(19) United States
(12) Patent Application Publication
(10) Pub. No.: US 2006/0206513 A1
(43) Pub. Date: Sep. 14, 2006

(54) Method for speed-efficient and memory-efficient construction of a trie

(75) Inventor: Baltasar Belyavsky, Toronto (CA)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/075,142

(22) Filed: Mar. 8, 2005

(51) Int. Cl. G06F 17/00

(52) U.S. Cl. 707/102

(57) ABSTRACT

A method in a data processing system for generating trie structures, comprised of the following steps: The method identifies mappings, which have elements, in a map file. The method advances to a element in a current mapping, wherein the element becomes a current element. Next, the method determines a presence in an output tree structure of a corresponding node which corresponds to the current element, through a single look-up for a reference to the corresponding node. Responsive to the presence of the corresponding node, the method sets the corresponding node as the current node. Responsive to an absence of the corresponding node, the method creates a new node for the output tree structure, wherein the new node corresponds to the current element, appends this new node as a child node to a current node, sets the new node as the current node, and stores a reference to this new node.

### BACKGROUND OF THE INVENTION

1. Technical Field

The present invention relates generally to an improved data processing system and, in particular, to a method, apparatus and computer program product for optimizing performance in a data processing system. Still more particularly, the present invention provides a method, apparatus, and computer program product for enhancing performance of a method for constructing trie structures.

2. Description of Related Art

A tree is a type of data structure in which nodes are connected by edges. The node at the top of a tree is called the root, which is why trees are often called inverted trees. There is only one root in a tree. Every node (except the root) has exactly one edge running upward to another node. The node above is called the parent of the node. Any node may have edges running downward to other nodes. These nodes below a given node are called child nodes and the parent node's children. The number of children at each parent node is referred to as the fan-out at that parent node. Any parent node may be considered to be the root of a sub-tree, which consists of the parent node, the parent node's children, the children nodes' children, and so on.

Inverted trees could be used to represent hierarchical file structures, for example. In this case, the nodes without children are files and the other nodes above the childless nodes are directories. Trees are used in everything from B-trees in databases and file systems, to game trees in game theory, to syntax trees in human or computer languages.

A trie is a special type of a tree structure. A trie is a multi-way tree structure useful for storing strings, for example. A single trie structure can be used to encode several strings, which all begin with the same element, by reusing any common elements encountered from left to right. The idea behind a trie is that all strings sharing a common stem or prefix hang off a common node. The elements in a string can be recovered from the corresponding trie by a scan from the root to the child node that corresponds to the element that ends the string. As one example, tries are used to store large dictionaries of English words in spelling-check programs and in natural-language “understanding” programs.

The current product that can utilize the method presented is the Map Migration software utility for the WBI Message Broker version 6.0, a product of International Business Machines Corporation in Armonk, N.Y., but the method has applications for any other software products that construct trie structures. The purpose of the Map Migration utility is to migrate existing customer map-files from an obsolete model to a new model. Each map-file consists of multiple mappings, where each mapping maps multiple source elements to a single target element.

The problem to be solved by the present invention can be abstracted into a purely theoretical problem of constructing a trie structure in the most efficient way. One step in prior art mechanisms for constructing trees is to iterate through the child nodes of the current parent node, comparing the current input element with each individual child node. Because the child nodes are not stored in a tree contiguously, the comparison process is lengthy.

For each comparison, the currently available method must identify the children of the parent node, and use the pointer to the child node to be examined in order to retrieve that child node so that a determination can be made as to whether that child node matches the element that may be added. After each comparison that does not result in a match, the currently available method must return to the parent node, identify whether the parent node has any more children, and if more children exist, to use the pointer to the next child node in order to retrieve the next child node for a determination of whether the next child node matches the input element. This inefficient process continues until the currently available method determines that no match was found between the input element and any of the child nodes, or that a match was found. If a match was found, the currently available method sets the child node corresponding to the matching element as the current node, and then iterates to the next input element to be matched. If no match was found, the currently available method adds a newly created node, corresponding to the current input element, as a child to the current node, which makes subsequent searches of the current node even more inefficient.

Therefore, it would be advantageous to have an improved method, apparatus, and computer program product for constructing a trie structure. The mechanism of the present invention, described below, improves the speed-efficiency of the conventional approach to trie construction, without deteriorating the algorithm's memory-efficiency.

### SUMMARY OF THE INVENTION

The present invention is a method in a data processing system for generating trie structures. The method is comprised of the following steps: The method identifies a plurality of mappings in a current map file in which each mapping in the plurality of mappings has a plurality of source path strings which map to a single target path string. Next, the method identifies a plurality of elements in each mapping's target path string. Next, the method advances to a subsequent element in a current mapping's target path string in the plurality of mappings, wherein the subsequent element becomes a current element. Responsive to advancing to the subsequent element in the current path string, the method determines whether a corresponding node in the new trie structure is present, in which the corresponding node corresponds to the current element, through a single look-up for a reference to the corresponding node. Responsive to a presence of the corresponding node, the method moves on to the next element in the path string. Responsive to an absence of the corresponding node, the method creates a new node for the trie structure, wherein the new node corresponds to the current element, and then the method stores a reference to the trie's new node, and moves on to the next element in the path string.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a block diagram of a preferred embodiment of the present invention including an example of the invention's input and an example of the invention's output;

FIG. 4 is a diagram of the correct trie output structure that results from mapping the two input path-strings a.b.d and a.c.d in accordance with a preferred embodiment of the present invention;

FIG. 5 is a diagram of an output structure for two distinct but identical input path-strings, a.b.d and a.b.d, that is never a possible result for mapping with the present invention, for the structure is no longer be a trie;

FIG. 6 is a diagram of the correct trie output structure that is always the result from mapping two distinct but identical input path-strings, a.b.d and a.b.d, in accordance with a preferred embodiment of the present invention;

FIG. 7 is a flowchart of the conventional approach for constructing a trie as applied to this problem;

FIG. 8 is a flowchart of the improved approach to constructing a trie in accordance with a preferred embodiment of the present invention;

FIG. 9 is a diagram of five input path strings and the resulting trie output structure constructed in accordance with a preferred embodiment of the present invention;

FIG. 10 is a code for a Java example of a generic implementation of the cache-key in accordance with a preferred embodiment of the present invention; and

FIG. 11 is code for a simplified implementation in Java of the cache-key in accordance with a preferred embodiment of the present invention.

### DETAILED DESCRIPTION OF THE PREFERRED EMBODIMENT

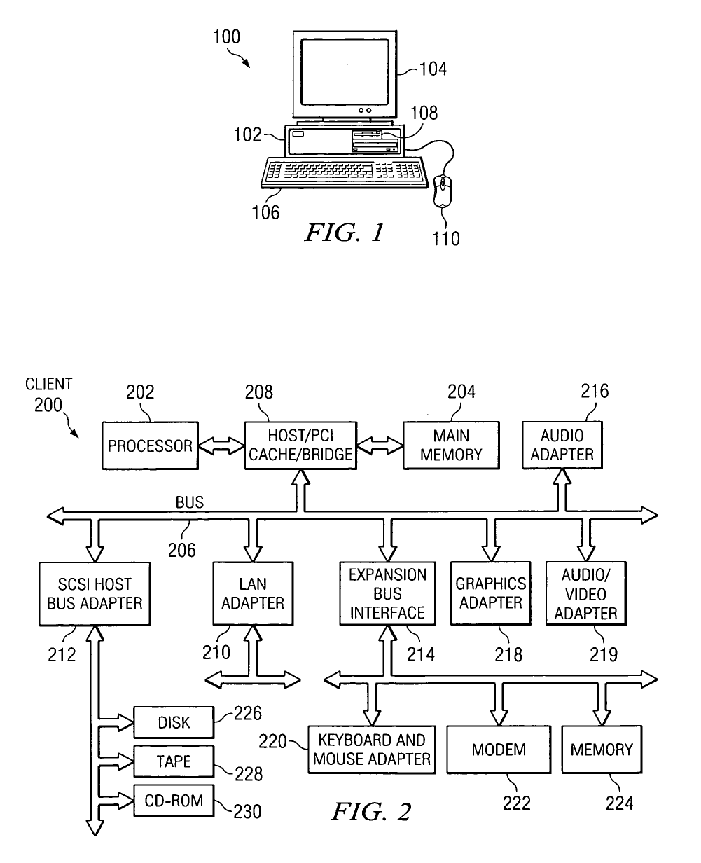

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

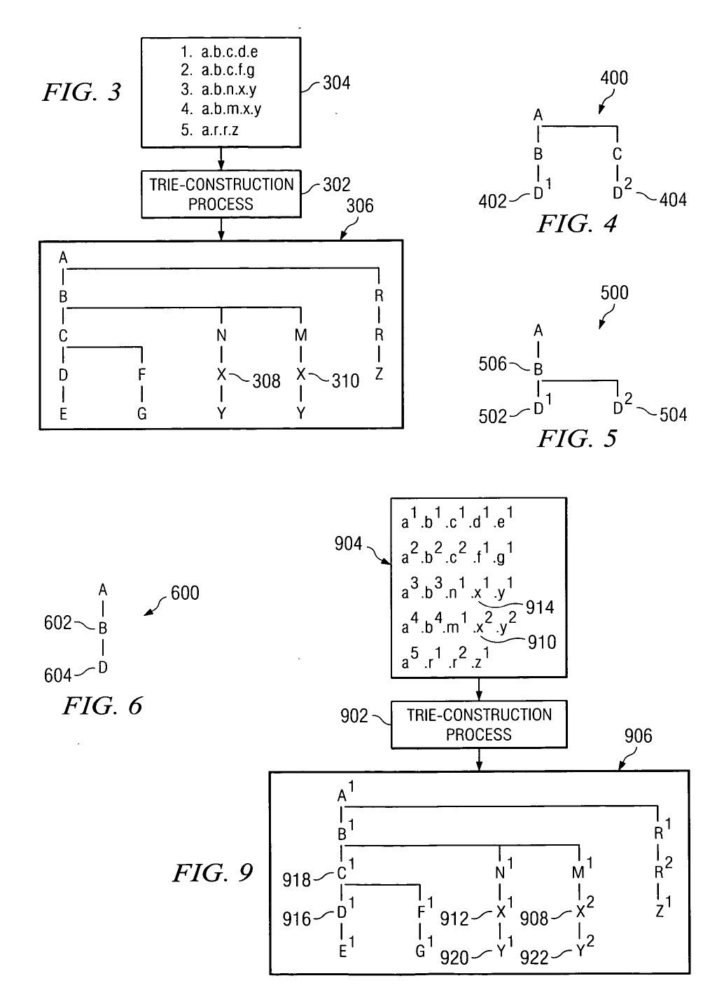

FIG. 3 is a block diagram of a preferred embodiment of a trie-construction process 302 including an example of the process' input map-model 304 and an example of process' output tree structure 306. The trie-construction process 302 can be implemented in a variety of forms, such as a method, a data processing system, or a computer program product in the form of a computer readable medium of instructions. The input map-model 304 is shown for a particular example, but the input may be any string of elements used to construct a trie. The output tree structure 306 is a structural map model in the form of a trie. The prior art map-model for the IBM WBI Message Broker version 6.0 is a purely declarative model, where the targets of all mappings are dot-delimited path-strings conforming to a certain meta-model, but the method has applications for any other path strings that are used to construct tries. FIG. 3 shows an example input map-model 304 of dot-delimited path-string targets in the prior art model. Number 2 in example 2 is for the dot-delimited path-string “a.b.c.f.g”.

The trie-construction process 302 generates a new map model, output tree structure 306 in the form of a trie. Trie-construction process 302 encodes the target of each mapping from input map-model 304 in a tree structure, such that the same tree is re-used to encode all the target path strings in a single map-file. FIG. 3 shows the output tree structure 306, encoding all five mapping targets from input map-model 304. Number 2 from input map-model 304, the dot-delimited path-string “a.b.c.f.g”, is one of the path-strings shown as part of the output tree structure 306. The output tree structure 306 is actually a “trie.”

A trie is a special type of a tree structure. A trie is a multi-way tree structure useful for storing strings, for example. A single trie structure can be used to encode several strings, which all begin with the same element, by reusing any common elements encountered from left to right. The idea behind a trie is that all strings sharing a common stem or prefix hang off a common node. The elements in a string can be recovered from the corresponding trie by a scan from the root to the child node that corresponds to the element that ends the string. As one example, tries are used to store large dictionaries of English words in spelling-check programs and in natural-language “understanding” programs.

The problem to be solved by the present invention can be abstracted into a purely theoretical problem of constructing a trie in the most efficient way. The illustrated examples depict generations of tries. From now on, the dot-delimited path-strings of the obsolete map-model example are referred to as the inputs to the trie construction method, and the resulting trie structure is referred to as the output of the method.

The following conditions apply to the inputs, in this illustrated example using the path-string example.

All input path-strings are absolute, beginning with the same element.

The input path-strings may contain loops, such as a.b.r.r.z or a.b.r.e.r.e.z. A loop occurs when any element, or sequence of elements, is repeated in a path-string.

The following conditions apply to the output, in this illustrated example using a trie structure corresponding to the path-string example.

Each node in the output structure corresponds to an element in an input path-string. However, the node in the output structure and the element in the path-string are always entirely distinct objects conforming to entirely distinct meta-models—i.e., the output structure is not simply a rearrangement of the input path-string elements, but the structure is an entirely new structure of objects which are unaware of their corresponding input path-string elements. To make this distinction clear, all elements in the input path strings are represented by lower-case letters (e.g. ‘a’), and all nodes in the output trie are represented by upper case letters (e.g. ‘A’).

The output structure may contain multiple instances of the same node (or sub-tree), but these duplicate nodes (or sub-trees) would never be siblings. For example, the output tree structure 306 contains multiple instances of the same node ‘X’ 308, 310, but these two instances are children of different nodes, not the same node, thus the two instances of ‘X’ 308, 310, are not siblings. This condition is just a formulation of the general rule that defines the trie structure.

Whenever a node is duplicated in the output structure, the instances of the duplicate node are always distinct objects of the same type. To make this distinction clear, each of the duplicate nodes is suffixed by a distinct super-script (e.g. ‘D¹’ and ‘D²’).

FIG. 4 shows that the correct trie output structure 400 that results from processing an input mapping model using the mechanism of the present invention. This illustrative example involves processing the two input path-strings a.b.d and a.c.d into an output trie. The instances of the duplicate node ‘D’ are suffixed by a distinct super-script (e.g. ‘D¹’ 402 and ‘D²’ 404).

FIG. 5 shows an output structure 500 that never is a possible result of processing the two distinct but identical input paths a.b.d and a.b.d using the mechanism of the present invention. This output structure in FIG. 5 is no longer a trie. This type of output structure is not generated because multiple instances of the same node ‘D’ cannot be siblings in a trie, and in FIG. 5 the two instances of ‘D’ 502, 504 are siblings, since they are both children of ‘B’ 506.

FIG. 6 shows the correct trie output structure 600 that always results from using the mechanism of the present invention to process two distinct but identical input path-strings, a.b.d and a.b.d. Where input path-strings have identical elements from left to right, the resulting trie structure would always encode all identical elements as the tree's stem, which is shared among all the tree branches (if there are any). Therefore, the multiple instances of ‘b’ and ‘d’ in the input path-strings do not result in multiple instances of ‘B’ 602 and ‘D’ 604 in the trie output structure.

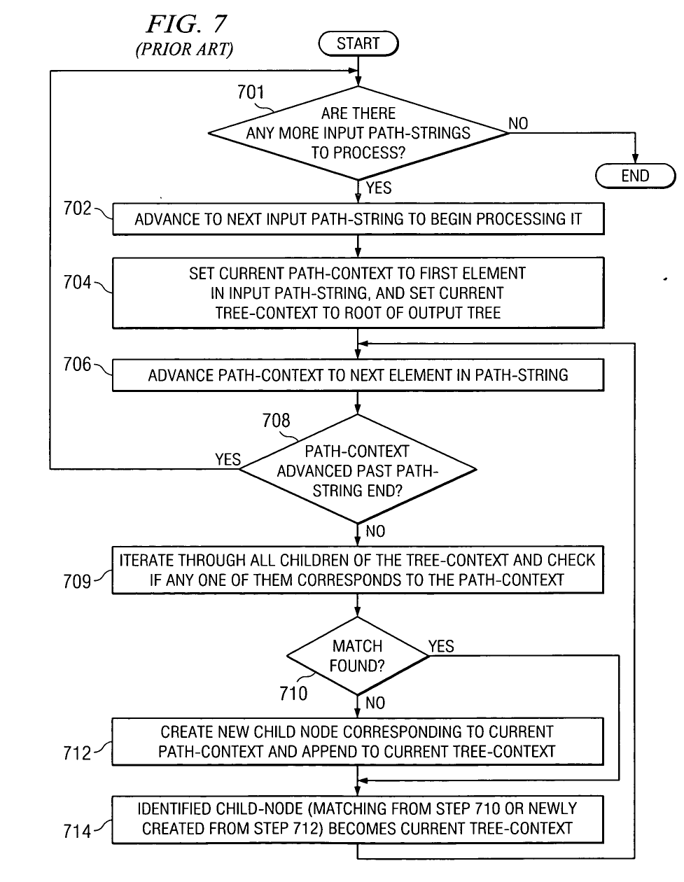

FIG. 7 shows a flowchart of a conventional approach for constructing a trie as applied to this problem, using an example of path-strings as input.

The process begins with iterating through each of the input path-strings. If there are no input path-strings to process, the process ends (step 701). If there are any input path-strings to process, the process advances to the next input path string to begin processing it (step 702).

For each new input path-string, the process sets the current path-context to the first element in the input path-string, and the current tree-context to the root of the output tree (step 704). If the root of the output tree does not exist yet, the root is created in step 704 by creating a node corresponding to the current path-context.

The process then advances the path-context to the next element in the path-string (step 706). The process determines whether the path-context has advanced past the end of the path-string (step 708). If the path-context has advanced past the end of the path-string, the path-string's elements are finished, and the process returns to step 701. Otherwise, the process continues to step 709.

The process checks if a tree-node corresponding to the path-element pointed to by the current path-context already exists among the children of the current tree-context (step 709). This check is performed by iterating through all of the existing child-nodes of the node pointed to by the current tree-context and checking if any one of them corresponds to the path-element pointed to by the current path-context.

If no match is found between the path-element pointed to by the current path-context and any one of the child nodes of the current tree-context, the process continues to step 712 (step 710). In step 712, a new node corresponding to the current path-context is to be added as a child node at the current tree-context. Therefore, the current tree-context is the node where to grow the tree by adding the newly created node as a new child node (step 712). The process creates a new child-node corresponding to the current path-context element and appends the new child node to the current tree-context. Thereafter, the process continues to step 714.

If a match is found between the path-element pointed to by the current path-context and one of the child nodes of the current tree-context, the process bypasses step 712 and proceeds to step 714 (step 710).

The identified child-node (either the child node that matches the path-element pointed to by the current path-context in step 710, or the new child node created in step 712) becomes the current tree-context (step 714). The process continues to advance through the input path-string by going back to step 706.

This conventional approach has the following performance characteristics. At step 709, the path-element pointed to by the current path-context must be compared with M elements corresponding to the M existing child nodes of the tree-node pointed to by the current tree-context. If the speed-efficiency of this mechanism is expressed as a function of m (which is the average fan-out at each node of the resulting tree) and n (which is the total number of nodes in the resulting tree), the speed is only as fast as O(m)·O(logₘn) for each input path string (where logₘn is the average length of an input-path string, which is equivalent to the average depth of the resulting tree). The speed-efficiency of this mechanism (for each input string path) is O(m·logₘn).

Because the output tree is an instance of an entirely new meta-model, each node in the output tree has no knowledge of or information about the node's corresponding path-element in the input path-string. The implementation of this mechanism requires that a temporary global hash-map be kept in memory in order to link each existing tree-node to the node's corresponding path-element. The average size of this hash-map is O(n) where n is the total number of tree-nodes in the resulting tree. The memory-efficiency of this mechanism is O(n).

The mechanism of the present invention, described below, improves the speed-efficiency without deteriorating the mechanism's memory-efficiency. The mechanism of the present invention utilizes a global cache which stores references to each new tree-node in the output-tree, and which is keyed on a special complex key. The cache key is composed of two pieces of information required to uniquely identify each node in the output trie. The performance using the mechanism of the present invention compares to the conventional solution as follows:

| | Conventional | Invention |
|---|---|---|
| Speed (per input path-string) | O(m · logₘn) | O(logₘn) |
| Memory usage | O(n) | O(n) |

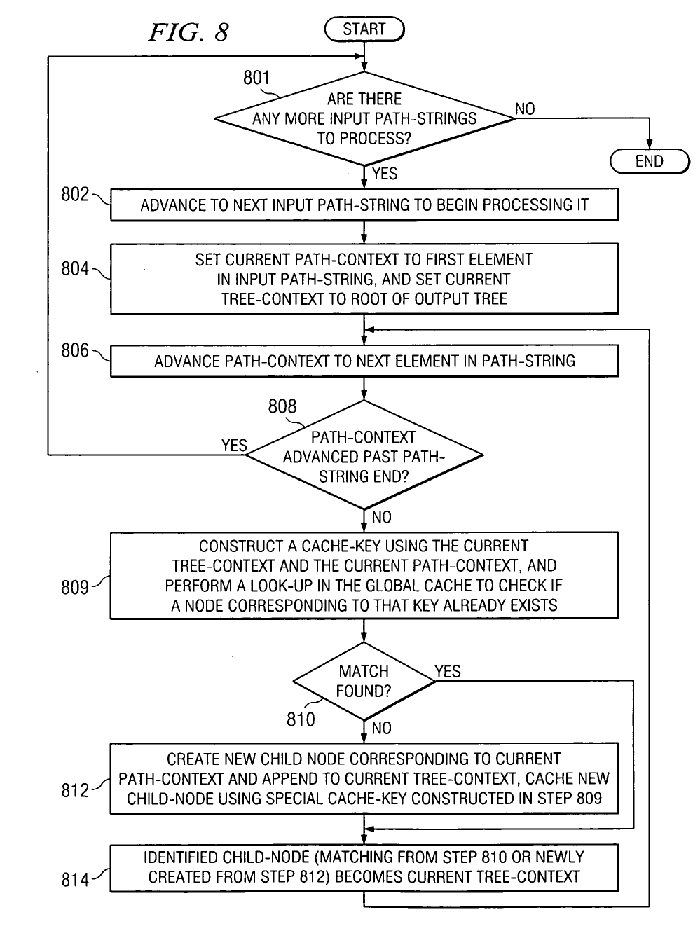

FIG. 8 shows the present invention's improved approach to constructing a trie, using an example of path-strings as input.

The process begins with iterating through each of the input path-strings. If there are no input path-strings to process, the process ends (step 801). If there are any input path-strings to process, the process advances to the next input path string to begin processing it (step 802).

For each new input path-string, the process sets the current path-context to the first element in the input path-string, and the current tree-context to the root of the output tree (step 804). If the root of the output tree does not exist yet, the root is created in step 804 by creating a node corresponding to the current path-context.

Then the process advances the path-context to the next element in the path-string (step 806). The process determines whether the path-context has advanced past the end of the path-string (step 808). If the path-context has advanced past the end of the path-string, the path-string's elements are finished, and the process returns to step 801. Otherwise, the process continues to step 809.

Then the process checks if a tree-node corresponding to the path-element pointed to by the current path-context already exists among the child nodes of the current tree-context (step 809). This check is performed by constructing a special cache-key and performing one look-up in the global cache, which is described in detail later.

If no match is found between the path-element pointed to by the current path-context and any of the child nodes of the current tree-context, the process continues to step 812 (step 810). In step 812, a new node corresponding to the current path-context is to be added as a child node at the current tree-context. Therefore, the current tree-context is the node where to grow the tree by adding the newly created node as a new child node (step 812). The process creates a new child-node corresponding to the current path-context element and appends the new child-node to the current tree-context. At this point, the process caches the newly created child node using the special cache-key which was constructed in step 809. Thereafter, the process continues to step 814.

If a match is found between the path-element pointed to by the current path-context and one of the child nodes of the current tree-context, the process bypasses step 812 and proceeds to step 814 (step 810).

The identified child-node (either the child node that matches the path-element pointed to by the current path-context in step 810, or the new child node created in step 812) becomes the current tree-context (step 814). The process continues to advance through the input path-string by going back to step 806.

The only two steps where this method differs from the conventional solution are steps 809 and 812. In step 809, instead of iterating through all of the existing child nodes of the current tree-context, the mechanism of the present invention performs a single cache look-up to determine if a node corresponding to the path-element pointed to by the current path-context already exists in the tree at the current tree-context. The inefficient method of iterating through all of the existing child nodes of the current tree-context, one child node at a time, is described above in the description of the related art.

In contrast, the mechanism of the present invention uses a speed-efficient single cache look-up to determine whether a tree-node corresponding to the current path-context already exists among the child nodes of the current tree-context. A single cache look-up is significantly faster than iterating through all existing child nodes of the current tree-context. Moreover, it is completely independent of the tree-s average fan-out, which is the average number of child-nodes for any parent-node in the tree.

And in step 812, if the mechanism of the present invention grows the tree by appending a new tree-node to the current tree-context, the mechanism also caches this new node using the cache-key constructed in step 809 in order to enable subsequent single cache look-ups.

The new method has the following performance characteristics. Since step 809 now involves only a single cache look-up, the step eliminates the need to traverse all existing child nodes of the current tree-context. This improves the speed-efficiency of this step from O(m) to O(1). The speed-efficiency of the new method (for each input path-string) is O(logₘn). The global cache, which is explained below, only stores a reference to each of the tree nodes keyed on a special key. Thus, the size of this cache is only as large as the total number of nodes in the resulting tree. The memory-efficiency of the new method is O(n).

The main vehicle enabling this approach is the global node-cache with the node-cache's custom keys. The node-cache is keyed on a complex object which consists of two pieces of information required to uniquely identify each tree-node X:
1. The instance of the parent node of node X (null if node X is the first node in the path—i.e. the node has no parent).
2. The type of the path-element corresponding to node X (this portion of the key is never null).

FIG. 9 shows five input path strings 904 and the resulting trie output structure 906 constructed with the process of the present invention 902. For the purposes of explanation, each distinct instance of an object, such as ‘X²’ 908, is suffixed with a distinct superscript. This applies to both elements of the input path-strings, such as ‘x²’ 910, and the nodes in the output trie structure, such as ‘X²’ 908. This notation is used to emphasize that, for example, the duplicate nodes ‘X¹’ 912 and ‘X²’ 908 are in fact two distinct trie-nodes of the same type. Furthermore, the notation meta(‘x’) is used to refer to the type of the path-elements ‘x¹’ 914 and ‘x²’ 910, which are distinct elements of the same type.

The key used to cache trie-node ‘D¹’ 916 in the example from FIG. 9, is composed of
1. The instance of the parent node, which is ‘C¹’918.
2. The type of the path-element corresponding to node ‘D¹’ 916, which is meta(‘d’). Thus, the trie-node ‘D¹’ 916 is cached on the key [‘C¹’ 918, meta(‘d’)].

As another example, consider the duplicate trie-nodes ‘Y¹’ 920 and ‘Y²’ 922 in the trie shown in FIG. 9. The node ‘Y¹’ 920 is cached on the key [(‘X¹’ 912, meta(‘y’)], and the node ‘Y²’ 922 is cached on the key [(‘X²’ 908, meta(‘y’)]. Thus, the two keys used to cache two duplicate nodes ‘Y¹’ 920 and ‘Y²’ 922 are in fact distinct. What distinguishes the two keys is the fact that ‘X¹’ 912 and ‘X²’ 908 are two distinct objects. This fact allows each trie-node to be uniquely keyed in the output trie, even duplicate nodes, because the duplicate nodes are never siblings, as mentioned in the discussion on conditions.

Returning to the new method's pseudo code, the cache-key, which is constructed in step 809 in order to perform the look-up, is constructed by combining the tree-node pointed to by the current tree-context with the meta-object of the path-element pointed to by the current path-context. If the look-up in step 809 does not result in a match, then in step 812 a new tree-node is instantiated and cached on the same key that has been constructed in step 809.

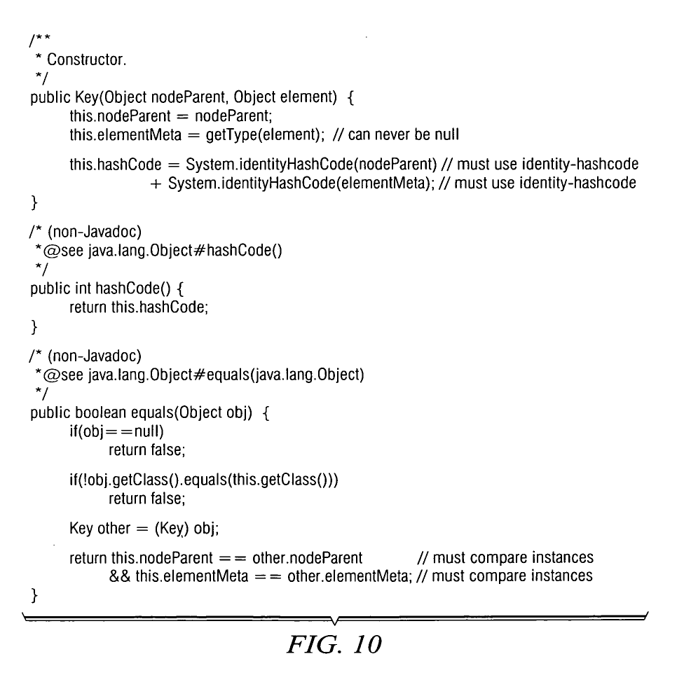

FIG. 10 shows a Java example of a generic implementation of the cache-key. Note that in Java the implementation of the cache-key can be simplified if the input path-strings do not conform to any meta-model and may simply be treated as string objects. The Java String class overrides the Object.hashCode( ) and Object.equals( ) methods to compare String objects “by value” as opposed to “by instance”. Thus, the cache-key can be simplified by treating the value of each String path-element as that path-element's meta-object.

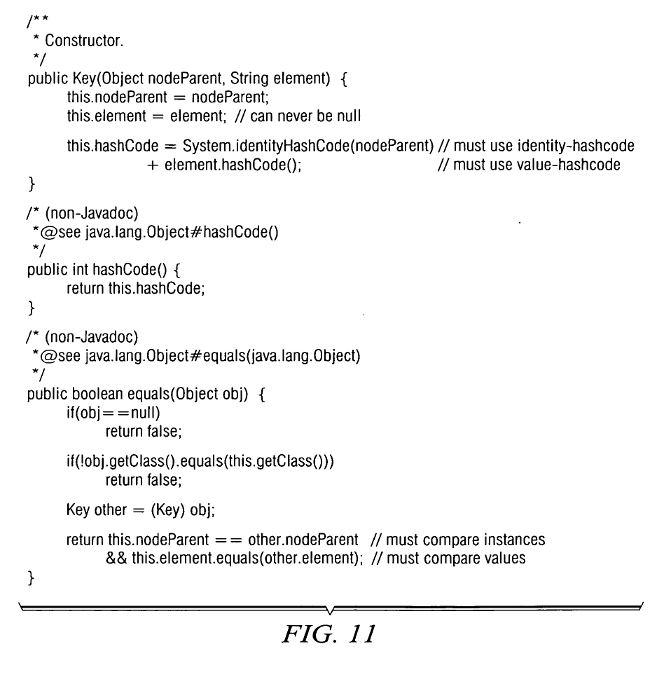

FIG. 11 shows a simplified implementation in Java of the cache-key.

The following is a logical proof that every node in a trie can be uniquely identified with a key composed of that node's parent node and the meta-object of the node's corresponding path-element. The general rule that defines a trie is that this tree may contain multiple instances of the same node (or sub-tree), but these duplicate nodes (or sub-trees) are guaranteed not to be siblings.

To simplify the problem, assume that one particular tree contains no duplicate nodes. In this case every new tree-node can be uniquely identified using only the meta-object of the node's corresponding path-element.

Now, extend the solution to be able to handle multiple instances of the same node within the tree. Think of the entire tree as an arrangement of sub-trees such that each sub-tree is guaranteed not to have any duplicate nodes. If the root-nodes of each of those sub-trees are added to the cache-key, the new extended key is guaranteed to uniquely distinguish between every node within the entire tree.

Furthermore, a trie structure guarantees that any duplicate nodes within the trie structure can never be siblings. The solution can be simplified by treating each node with all the node's immediate children as a sub-tree which is guaranteed to contain no duplicate nodes. Thus, a key to uniquely identify any node X within the entire trie is simply the combination of the parent node of X (which is the root-node of the sub-tree containing X) and the meta-object of the path-element corresponding to node X.

The problem solved by the present invention can be abstracted into the purely theoretical problem of constructing a trie structure in the most efficient way. The mechanism of the present invention, described above, improves the speed-efficiency of the conventional approach to trie construction, without deteriorating the mechanism's memory-efficiency.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for generating tree structures, the method comprising:
identifying a plurality of mappings in a current map file in which each mapping in the plurality of mappings has a plurality of elements;
advancing to a subsequent element in a current mapping in the plurality of mappings, wherein the subsequent element becomes a current element;
responsive to advancing to the subsequent element in the current mapping, determining whether a corresponding node in an output tree structure is present, in which the corresponding node corresponds to the current element, through a single look-up for a reference to the corresponding node;
responsive to a presence of the corresponding node, setting the corresponding node as the current node; and
responsive to an absence of the corresponding node, creating a new node for the output tree structure, wherein the new node corresponds to the current element, appending this new node as a child node to a current node, setting the new node as the current node, and storing a reference to this new node.

2. The method of claim 1 further comprising:
responsive to advancing past an end of the current mapping, selecting an unprocessed mapping as the current mapping and repeating the advancing step for the current mapping.

3. The method of claim 1 further comprising:
repeating the advancing step responsive to a presence of the corresponding node.

4. The method of claim 1 further comprising:
repeating the advancing step after creating the new node for the output tree structure, wherein the new node corresponds to the current element.

5. The method of claim 1 further comprising:
setting a first element in the current mapping as the current element prior to a first time in which the advancing step is performed; and
responsive to setting the first element, creating a root for the output tree structure to correspond to the first element, and setting the root as the current node, prior to the first time in which the advancing step is performed.

6. The method of claim 1, wherein each mapping in the plurality of mappings is comprised of a plurality of source path strings which map to a single target path string.

7. The method of claim 1, wherein an input map file is a declarative model and wherein an output map file is a structural model.

8. The method of claim 1, wherein the output tree structure is a trie.

9. The method as recited in claim 1, wherein the determining step comprises determining whether the corresponding node in the output tree structure is present, in which the corresponding node corresponds to the current element, through the single look-up for a reference to the corresponding node, instead of iterating through all of the current node's child nodes.

10. The method as recited in claim 1, wherein the determining step comprises determining whether the corresponding node in the output tree structure is present, in which the corresponding node corresponds to the current element, through the single look-up for the reference to the corresponding node, wherein the look-up for the reference for a node in question is performed using a cache-key composed of two pieces of information, an instance of a parent node of the node in question (which is the current node) and a meta-object of an element corresponding to the node in question (which is the meta-object of the current element).

11. The method as recited in claim 1, wherein the creating step comprises creating the new node for the output tree structure, wherein the new node corresponds to the current element, and storing the reference to the new node in a global cache, wherein the storage of the reference is performed using a cache-key composed of two pieces of information, the new node's parent node and a meta-object of an element corresponding to the new node.

12. A data processing system for generating tree structures, the data processing system comprising:
identifying means for identifying a plurality of mappings in a current map file in which each mapping in the plurality of mappings has a plurality of elements;
advancing means for advancing to a subsequent element in a current mapping in the plurality of mappings, wherein the subsequent element becomes a current element;
responsive to advancing to the subsequent element in the current mapping, determining means for determining whether a corresponding node in the output tree structure is present, in which the corresponding node corresponds to the current element, through a single look-up for a reference to the corresponding node;
responsive to a presence of the corresponding node, setting means for setting the corresponding node as the current node; and
responsive to an absence of the corresponding node, creating means for creating a new node for the output tree structure, wherein the new node corresponds to the current element, appending means for appending this new node as a child node to a current node, setting means for setting the new node as the current node, and storing means for storing the reference to this new node.

13. The data processing system of claim 12 further comprising:
responsive to advancing past an end of the current mapping, selecting means for selecting an unprocessed mapping as the current mapping and repeating the advancing step for the current mapping.

14. The data processing system of claim 12 further comprising:
repeating means for repeating the advancing step responsive to a presence of the corresponding node.

15. The data processing system of claim 12 further comprising:
repeating means for repeating the advancing step after creating the new node for the output tree structure, wherein the new node corresponds to the current element.

16. The data processing system of claim 12 further comprising:
setting means for setting a first element in the current mapping as the current element prior to a first time in which the advancing step is performed; and
responsive to setting the first element, creating means for creating a root for the output tree structure to correspond to the first element, and setting means for setting the root as the current node, prior to the first time in which the advancing step is performed.

17. The data processing system of claim 12, wherein each mapping in the plurality of mappings is comprised of a plurality of source path strings which map to a single target path string.

18. The data processing system of claim 12, wherein an input map file is a declarative model and wherein an output map file is a structural model.

19. The data processing system of claim 12, wherein the output tree structure is a trie.

20. A computer program product on a computer-readable medium for use in a data processing system for generating a tree, the computer program product comprising:
first instructions for identifying a plurality of mappings in a current map file in which each mapping in the plurality of mappings has a plurality of elements;
second instructions for advancing to a subsequent element in a current mapping in the plurality of mappings, wherein the subsequent element becomes a current element;
responsive to advancing to the subsequent element in the current mapping, third instructions for determining whether a corresponding node in an output tree structure is present, in which the corresponding node corresponds to the current element, through a single look-up for a reference to the corresponding node;
responsive to a presence of the corresponding node, fourth instructions for setting the corresponding node as the current node; and
responsive to an absence of the corresponding node, fifth instructions for creating a new node for the output tree structure, wherein the new node corresponds to the current element, appending this new node as a child node to a current node, setting this new node as the current node, and storing a reference to this new node.
